(19) United States
(12) Patent Application Publication
(10) Pub. No.: US 2021/0080937 A1
(43) Pub. Date: Mar. 18, 2021

(54) INFORMATION ANALYSIS DEVICE, INFORMATION ANALYSIS METHOD, AND STORAGE MEDIUM STORING INFORMATION ANALYSIS PROGRAM

(71) Applicant: MITSUBISHI ELECTRIC CORPORATION, Tokyo (JP)

(72) Inventors: Satoshi SAKURAI, Tokyo (JP); Hiroyasu NEGISHI, Tokyo (JP); Masaru KIMURA, Tokyo (JP); Tomoharu AWANO, Tokyo (JP); Kosuke HOSOYA, Tokyo (JP)

(73) Assignee: MITSUBISHI ELECTRIC CORPORATION, Tokyo (JP)

(21) Appl. No.: 16/968,319

(22) PCT Filed: Feb. 15, 2018
(86) PCT No.: PCT/JP2018/005178

§ 371 Date: Aug. 7, 2020

(51) Int. Cl. G05B 19/418

(52) U.S. Cl. CPC G05B 19/4188; G05B 2219/32088

(57) ABSTRACT

An information analysis device includes a processor and a storage unit. The processor includes: a worker information calculator to calculate worker information including at least one of an action speed of a worker and a position of the worker based on first information acquired from a first detector; a progress information calculator to calculate work progress information including a progress speed of the work based on second information acquired from a second detector; a product information calculator to calculate product information including at least one of a stock quantity of the product and a position of the product based on third information acquired from a third detector; and an information connection extractor to generate data indicating a connection between at least two types of information, among the worker information, the work progress information and the product information, in regard to each of a plurality of predetermined time slots.

### TECHNICAL FIELD

The present invention relates to an information analysis device that analyzes information regarding work for producing a product and an information analysis method and an information analysis program used for analyzing information regarding work for producing a product.

### BACKGROUND ART

To smoothly advance operations in a factory, a method called PDCA (plan-do-check-act) is used. PDCA is a method for continuously improving a product (referred to also as “manufactured goods”) and work by repeating four stages of plan (designing), do (execution), check (evaluation) and act (improvement). By use of PDCA, history records regarding the work for producing a product can be visualized in an easy-to-understand manner and it becomes easier to grasp working conditions.

### PRIOR ART REFERENCE

### Patent Reference

Patent Reference 1: Japanese Patent Application Publication No. 2012-22602

### SUMMARY OF THE INVENTION

### Problem to be Solved by the Invention

However, it is difficult for a worker to extract and grasp a tendency of data over a long period (e.g., a gradual change in data over a long period) from the visualized data. Accordingly, there are cases where a worker cannot correctly grasp the working conditions over a long period and cannot appropriately improve the work.

An object of the present invention, which has been made to resolve the above-described problem with the conventional technology, is to provide an information analysis device, an information analysis method and an information analysis program that make it possible to extract data indicating a mutual connection between different types of history information from history information regarding work for producing a product and present the data as the result of the extraction in a format easy to recognize for the worker.

### Means for Solving the Problem

An information analysis device according to an aspect of the present invention is an information analysis device that analyzes information regarding work for producing a product, including a processor to process information and a storage unit. The processor includes the processor includes a worker information calculator to calculate worker information including at least one of an action speed of a worker and a position of the worker based on first information acquired from a first detector that detects action of the worker and to make the storage unit store the worker information; a progress information calculator to calculate work progress information including a progress speed of the work based on second information acquired from a second detector that detects the work performed by the worker and to make the storage unit store the work progress information; a product information calculator to calculate product information including at least one of a stock quantity of the product and a position of the product based on third information acquired from a third detector that detects the product and to make the storage unit store the product information; and an information connection extractor to generate data indicating a connection between at least two types of information, among the worker information, the work progress information and the product information accumulated in the storage unit, in regard to each of a plurality of predetermined time slots and to output the data to an information presentation unit that presents information.

An information analysis method according to another aspect of the present invention is an information analysis method for analyzing information regarding work for producing a product, including the steps of: calculating worker information including at least one of an action speed of a worker and a position of the worker based on first information acquired from a first detector that detects action of the worker and making a storage unit store the worker information; calculating work progress information including a progress speed of the work based on second information acquired from a second detector that detects the work performed by the worker and making the storage unit store the work progress information; calculating product information including at least one of a stock quantity of the product and a position of the product based on third information acquired from a third detector that detects the product and making the storage unit store the product information; and generating and outputting data indicating a connection between at least two types of information, among the worker information, the work progress information and the product information accumulated in the storage unit, in regard to each of a plurality of predetermined time slots.

### Effect of the Invention

According to the present invention, it is possible to extract data indicating a mutual connection between different types of history information from history information regarding work for producing a product and present the data as the result of the extraction in a format easy to recognize for a worker. Accordingly, the worker can appropriately improve the work.

### BRIEF DESCRIPTION OF THE DRAWINGS

FIG. 1 is a functional block diagram schematically showing an information analysis device according to an embodiment of the present invention.

FIG. 2 is an explanatory diagram showing the operation of the information analysis device according to the embodiment.

FIG. 3 is a diagram schematically showing a hardware configuration of the information analysis device according to the embodiment.

FIG. 4 is a flowchart showing the operation of an information connection extractor of the information analysis device according to the embodiment.

FIG. 5 is a diagram showing an example of analysis result data outputted by the information connection extractor of the information analysis device according to the embodiment.

### MODE FOR CARRYING OUT THE INVENTION

An information analysis device, an information analysis method and an information analysis program according to an embodiment of the present invention will be described below with reference to the accompanying drawings. The following embodiment is just an example and a variety of modifications are possible within the scope of the present invention.

### (1) Configuration

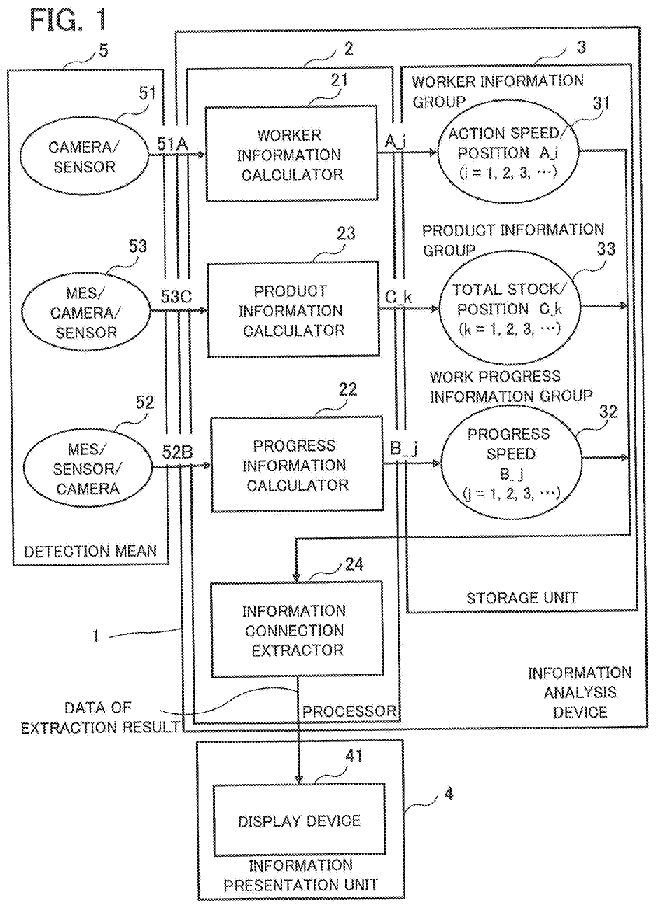

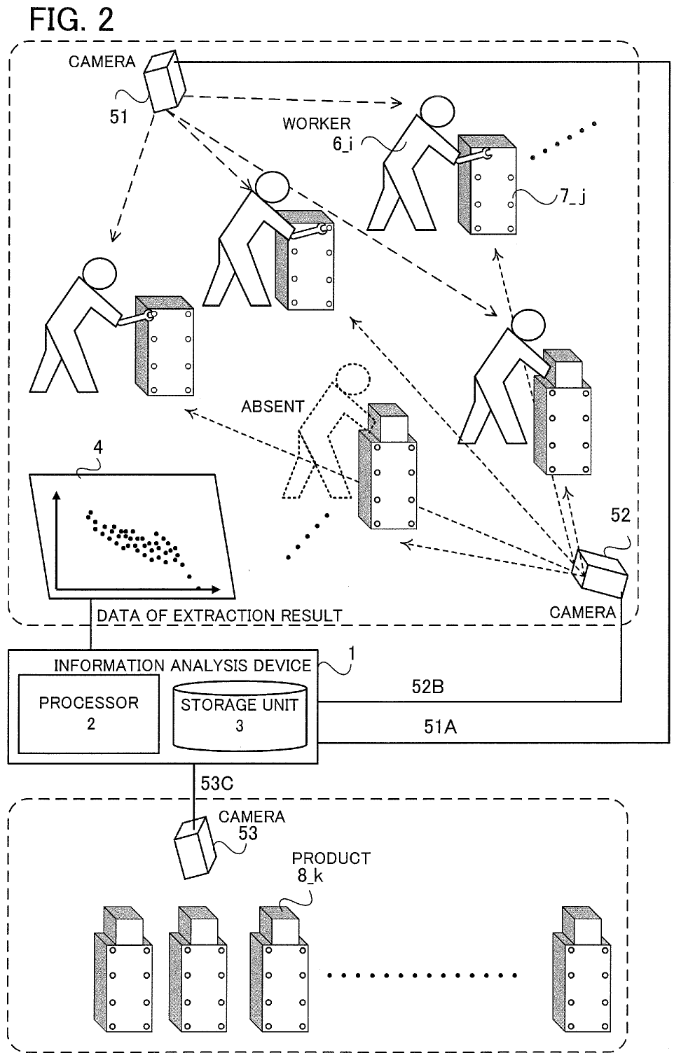

FIG. 1 is a functional block diagram schematically showing an information analysis device 1 according to an embodiment of the present invention. FIG. 2 is an explanatory diagram showing the operation of the information analysis device 1. The information analysis device 1 is a device capable of executing the information analysis method according to the embodiment. As shown in FIG. 1, the information analysis device 1 includes a processor 2 that acquires information regarding production of a product from a detection means 5 and processes the acquired information and a storage unit 3 that stores information.

An information presentation unit 4 that presents information to a worker is connected to the information analysis device 1. The information presentation unit 4 includes, for example, a display device 41 that provides the worker with an image. It is also possible to provide the information presentation unit 4 as a part of the information analysis device 1.

The detection means 5 is connected to the information analysis device 1. The detection means 5 includes, for example, a first detector 51 for detecting the worker (e.g., worker 6_i in FIG. 2), a second detector 52 that detects work performed by the worker (e.g., intermediate product 7_i in FIG. 2), and a third detector 53 that detects the product (e.g., product 8_k in FIG. 2). The detection means 5 is, for example, a camera that captures images of the worker, the work and the product, a sensor that detects them, an input device operated by the worker, or the like in a manufacturing execution system (MES). The detection by the detection means 5 is performed repeatedly or continuously. Further, the result of the detection by the detection means 5 may include date and time information indicating the date and time of the detection.

As shown in FIG. 1, the processor 2 includes a worker information calculator 21, a progress information calculator 22, a product information calculator 23 and an information connection extractor 24.

The worker information calculator 21 calculates worker information A_i (i is a positive integer) including at least one of an action speed of the worker and the position of the worker based on first information 51A acquired from the first detector (camera in FIG. 2) 51 as a means for detecting the action of the worker (e.g., 6_i in FIG. 2) and outputs the worker information A_i to the storage unit 3 to make the storage unit 3 store the worker information A_i. The reference character i represents a number for distinguishing between workers. In the storage unit 3, the worker information A_i is accumulated with the passage of time. The accumulated worker information A_i constitutes a worker information group 31. The first detector 51 is, for example, a camera (shown in FIG. 2) that captures images of the worker or a sensor that detects the worker as a detection target.

The position of the worker can be detected by analyzing a camera image. The position of the worker can be also detected by making the worker carry a receiver for receiving a beacon transmitted from a beacon transmitter. There is no limitation on the method of detecting the position of the worker; the position of the worker may be detected by using any other method.

The action (e.g., action speed) of the worker can be detected by analyzing camera images. The action of the worker can be also estimated from motion of the skeletal structure (bones) of the human body obtained by analyzing camera images. The action of the worker may also be detected by using position sensors attached to the worker's hands, feet, etc. The action of the worker may include motion of the human body such as motion of a fingertip or motion of the line of sight detected in camera images, biological information such as the heart rate or the level of fatigue, and the like. Further, the action of the worker may be detected as a particular action such as standing up, sitting down, screwing, soldering or the like. There is no limitation on the method of detecting the action of the worker; the action of the worker may be detected by using any other method.

The progress information calculator 22 calculates work progress information B_j (j is a positive integer) including a progress speed of the work based on second information 52B acquired from the second detector 52 as a means for detecting the work performed by the worker and outputs the work progress information B_j to the storage unit 3 to make the storage unit 3 store the work progress information B_j. The reference character j represents a number for distinguishing between different items of work. The second detector 52 is, for example, an input device of the MES operated by the worker, a camera that captures images of the worker or the intermediate product (e.g., 7_j shown in FIG. 2), or a sensor that detects the worker or the intermediate product as a detection target. There is no limitation on the method of detecting the progress speed of the work; the progress speed of the work may be detected by using any other method.

The product information calculator 23 calculates product information C_k (k is a positive integer) including at least one of the stock quantity of the product and the position of the product based on third information 53C acquired from the third detector 53 as a means for detecting the product and outputs the product information C_k to the storage unit 3 to make the storage unit 3 store the product information C_k. The reference character k represents a number for distinguishing between products. The third detector 53 is, for example, an input device of the MES operated by the worker, a camera that captures images of the product (8_k in FIG. 2), or a sensor that detects the product as a detection target. The product includes a final product (e.g., 8_k shown in FIG. 2) as a completed product or an intermediate product (e.g., 7_j shown in FIG. 2) as the product before completion.

The product information calculator 23 may calculate, for example, the position and the stock quantity of a material used for the work, the position and the stock quantity of the product (8_k in FIG. 2) produced as the result of the work, and the position and the stock quantity of the intermediate product (7_j in FIG. 2). The position of the product may be detected by, for example, a position sensor attached to the product. The stock quantity may be detected by, for example, analyzing camera images or recording the number of products placed at predetermined storage positions of the products. It is also possible to detect the stock quantity by input operations performed by a human, measurement of total weight of the products, or the like. There is no limitation on the method of detecting the stock quantity; the stock quantity may be detected by using any other method.

The information connection extractor 24 generates data indicating a connection between two types of information, among the worker information A_i (i=1, 2, . . . ), the work progress information B_j (j=1, 2, . . . ) and the product information C_k (k=1, 2, . . . ) as history information accumulated in the storage unit 3, in regard to each of a plurality of predetermined time slots. For example, the information connection extractor 24 extracts and outputs data indicating a connection between the worker information A_i and the work progress information B_j, data indicating a connection between the work progress information B_j and the product information C_k, or data indicating a connection between the product information C_k and the worker information A_i.

The information presentation unit 4 outputs the data obtained in regard to each of the plurality of time slots (#1, . . . , #m, . . . , #M). The information presentation unit 4 includes the display device 41, for example, and presents the worker with the data supplied from the information connection extractor 24 by displaying the data.

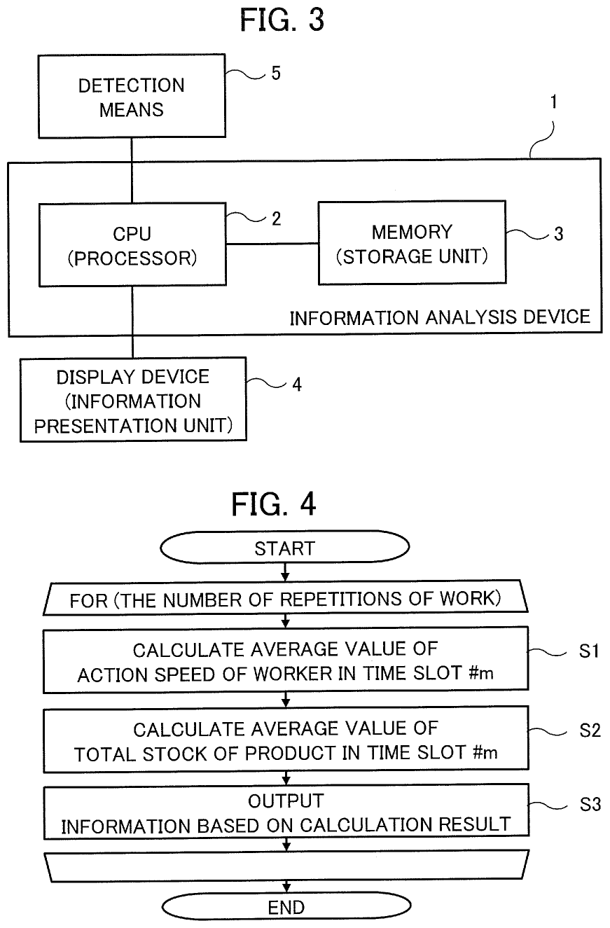

FIG. 3 is a diagram schematically showing a hardware configuration of the information analysis device 1 according to the embodiment. In FIG. 3, each component identical or corresponding to a component shown in FIG. 1 is assigned the same reference character as that shown in FIG. 1. As shown in FIG. 3, the information analysis device 1 includes a CPU (Central Processing Unit) as the processor 2 and a memory as the storage unit 3. The information analysis device 1 may be a general-purpose computer. The memory can store the information analysis program in addition to the various types of information shown in FIG. 1. The CPU is capable of implementing the functions of the processor 2 shown in FIG. 1 by executing the information analysis program.

### (2) Operation

Next, the operation of the information connection extractor 24 will be described below. The information connection extractor 24 generates data indicating a connection between at least two types of information, among the worker information A_i (i=1, 2, . . . ), the work progress information B_j (j=1, 2, . . . ) and the product information C_k (k=1, 2, . . . ) as the history information accumulated in the storage unit 3, in regard to each of a plurality of predetermined time slots #m (m=1, 2, . . . , M). The time slot is set as, for example, a time of a certain length, a time from the start of the work by the worker to the completion of the product, or the like. The information connection extractor 24 supplies the information presentation unit 4 with a plurality of pieces of data generated in regard to each of the plurality of time slots #m (m=1, 2, . . . , M), namely, the data in a long period including the plurality of time slots.

Concrete examples of the data indicating the connection between two types of information extracted by the information connection extractor 24 will be described below as “example 1” to “example 7”. However, the connected data are not limited to the examples described below.

The “example 1” is data indicating the connection between the progress speed of work and the action speed of the worker performing the work corresponding to the progress speed. The progress speed of work is, for example, a progress rate of the work. The action speed of the worker is, for example, the speed of movement of the worker's hand. The data indicating the connection between the progress speed of work and the action speed of the worker performing the work corresponding to the progress speed may be data indicating the connection between a representative value (e.g., average value) of the progress speed of the work and a representative value (e.g., average value) of the action speed of the worker.

The “example 2” is data indicating the connection between the progress speed of work and the stock quantity of the product produced by the work corresponding to the progress speed. The stock quantity of the product can include the number of items of the completed product and the number of items of the intermediate product, for example. The data indicating the connection between the progress speed of work and the stock quantity of the product produced by the work corresponding to the progress speed may be data indicating the connection between a representative value (e.g., average value) of the progress speed of the work and a representative value (e.g., average value) of the stock quantity of the product.

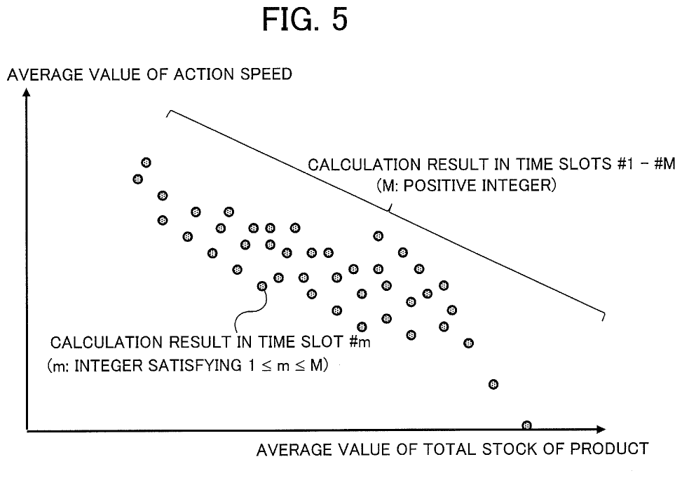

The “example 3” is data indicating the connection between the stock quantity of the product and the action speed of the worker performing the work of producing the product corresponding to the stock quantity. The stock quantity of the product is the same as that in the “example 2”. The action speed of the worker is, for example, the speed of movement of the worker's hand. The data indicating the connection between the stock quantity of the product and the action speed of the worker performing the work corresponding to the stock quantity may be data indicating the connection between a representative value (e.g., average value) of the progress speed of the work and a representative value (e.g., average value) of the stock quantity of the product. The “example 3” is an example shown in FIG. 4 and FIG. 5.

The “example 4” is data indicating the connection between the position of the worker and the stock quantity of the product. As indicated as the worker 6_i in FIG. 2, the position of the worker is, for example, information indicating the ratio of workers at work, indicating how many workers among a plurality of workers are at predetermined working positions. The stock quantity of the product is the same as that in the “example 2”. The data indicating the connection between the position of the worker and the stock quantity of the product may be data indicating the connection between a representative value (e.g., average value) of the ratio of workers at work and a representative value (e.g., average value) of the stock quantity of the product.

The “example 5” is data indicating the connection between the position of the worker and the progress speed of the work performed by the worker. The position of the worker is the same as that in the “example 4”. The data indicating the connection between the position of the worker and the progress speed of the work may be data indicating the connection between a representative value (e.g., average value) of the ratio of workers at work and a representative value (e.g., average value) of the progress speed of the work.

The “example 6” is data indicating the connection between a time slot and the progress speed of the work in the time slot. The data indicating the connection between the time slot and the progress speed of the work may be data indicating the connection between the time slot and a representative value (e.g., average value) of the progress speed of the work in the time slot.

The “example 7” is data including statistical changes over a long period (i.e., a period including a plurality of time slots) obtained by acquiring the data indicating the connection over the long period in one or more of the aforementioned “example 1” to “example 6”.

The information connection extractor 24 generates data indicating the extracted information connection and supplies the data to the information presentation unit 4. The information presentation unit 4 displays the received data on the display device 41.

FIG. 4 is a flowchart showing the operation of the information connection extractor 24 of the information analysis device 1. As an example, FIG. 4 shows the flow of a process of extracting the connection between the stock quantity of a product and a work speed when a worker repeats work of producing a final product PB by processing an intermediate product PA.

In step S1, the information connection extractor 24 calculates the average value of the hand movement speed (i.e., action speed) outputted by the worker information calculator 21 in a time slot #m (m=1, 2, . . . , M) from a time point when the worker picks up the intermediate product PA to a time point when the worker completes the production of the final product PB. Here, M is a positive integer.

In step S2, the information connection extractor 24 calculates the average value of the stock quantity of the final product PB outputted by the product information calculator 23 in the same time slot #m.

In step S3, the information connection extractor 24 outputs the average value of the hand movement speed calculated in the step S1 and the average value of the stock quantity of the final product PB calculated in the step S2 to the information presentation unit 4. The above processing is repeated for the number of times of the work performed by the worker (e.g., M times).

The worker information calculator 21, the progress information calculator 22 and the product information calculator 23 do not have to calculate unnecessary information depending on the purpose. For example, when the progress of the work is stopped due to depletion of the stock of the intermediate product PA, the worker information calculator 21 does not need to calculate the action speed and the position of the worker, and the product information calculator 23 just needs to calculate the stock quantity of the final product PB.

FIG. 5 is a diagram showing an example of analysis result data outputted by the information connection extractor 24 of the information analysis device 1 according to the embodiment. The information presentation unit 4 displays the analysis result data received from the information connection extractor 24 on the display device 41 as an image. The analysis result data may be displayed in regard to each character string, each table, each graph, each photo of the inside of a factory, or each map of a factory. Further, the display format can be any format easily understandable for the worker. In FIG. 5, as an output example (i.e., display example), the data of the analysis result (i.e., calculation result) are plotted in a two-dimensional coordinate system having a vertical axis representing the average value of the action speed as the hand movement speed calculated by the information connection extractor 24 and a horizontal axis representing the average value of the stock quantity of the product. In FIG. 5, one dot indicates the analysis result data in one time slot, that is, the analysis result data obtained by one loop of the processing of the steps S1 to S3 in FIG. 4.

### (3) Effect

As described above, with the information analysis device 1, the information analysis method and the information analysis program according to the embodiment, the result of the analysis regarding the work over a long period including a plurality of time slots can be presented in a format easily understandable for the worker. Specific details are as follows: Normally, the worker does not notice a slight decrease (e.g., decrease for several percent) in the action speed in work. However, the slight decrease in the action speed in work will appear as a detectable numerical value (decrease in the stock quantity) in the stock quantity of the final product which is the result of the work by a large number of workers over a long time. The information analysis device 1 according to the embodiment has a function that makes it possible to present the result of such work over a long period in a format easily recognizable for the worker.

### (4) Modifications

When the stock quantity of the intermediate product (which may also be a representative value, e.g., the average value, of the stock quantity in a certain time slot) is judged to be smaller than a predetermined reference quantity in a time slot in which the progress speed of the work (which may also be a representative value, e.g., the average value, of progress conditions of a plurality of workers) is slower than a predetermined reference speed, the information connection extractor 24 may output information indicating that the stock quantity of the intermediate product is small to the information presentation unit 4. In this case, the progress speed of the work decreases due to the shortage of the intermediate products, and thus it is possible to prompt the workers performing the work of producing the intermediate product to increase the number of the intermediate products by displaying that the stock quantity of the intermediate product is small.

When it is judged that there is an absent worker whose position is deviated from the predetermined working position in a time slot in which the progress speed of the work (which may also be a representative value, e.g., the average value, of progress conditions of a plurality of workers) is slower than a predetermined reference progress speed, the information connection extractor 24 may output information indicating the absent worker to the information presentation unit. In this case, by checking a display indicating that the worker was not at the predetermined working position, the worker can recognize that the time of the absence was longer than a prescribed time or the frequency of absence was higher than a prescribed frequency.

Further, when the action speed of a worker (which may also be a representative value, e.g., the average value, of the action speeds of a plurality of workers) is judged to be slower than a predetermined reference action speed in a time slot in which the stock quantity of an intermediate product (e.g., 7_j in FIG. 2) (which may also be a representative value, e.g., the average value, of the stock quantity in a certain time slot) is less than a predetermined reference quantity, the information connection extractor 24 may output information indicating that the stock quantity of the intermediate product is small to the information presentation unit. In this case, the action speed of the worker decreases due to the shortage of the intermediate products, and thus it is possible to prompt the workers performing the work of producing the intermediate product to increase the number of the intermediate products by displaying that the stock quantity of the intermediate product is small.

Furthermore, when the action speed of a worker (which may also be a representative value, e.g., the average value, of the action speeds of a plurality of workers) is judged to be slower than a predetermined reference action speed in a time slot in which the stock quantity of an intermediate product (e.g., 7_j in FIG. 2) (which may also be a representative value, e.g., the average value, of the stock quantity in a certain time slot) is larger than a predetermined reference quantity, the information connection extractor 24 may output information indicating that the action speed of the worker is slow to the information presentation unit. In this case, the action speed of the worker decreases even though the number of intermediate products is sufficient, and thus it is possible to prompt the worker performing the work of producing the final product by using the intermediate product to increase the action speed in the work.

### DESCRIPTION OF REFERENCE CHARACTERS

1: information analysis device, 2: processor, 3: storage unit, 4: information presentation unit, 5: detection means, 6_i: worker, 7_j: intermediate product (product), 8_k: final product (product), 21: worker information calculator, 22: progress information calculator, 23: product information calculator, 24: information connection extractor, 31: worker information group, 32: work progress information group, 33: product information group, 41: display device, 51: first detector, 51A: first information, 52: second detector, 52B: second information, 53: third detector, 53C: third information, A_i: worker information, B_j: work progress information, C_k: product information.

1. An information analysis device that analyzes information regarding work for producing a product, comprising:
a processor to execute a program; and
a memory to store the program which, when executed by the processor, performs
a process of calculating worker information including at least one of an action speed of a worker and a position of the worker based on first information acquired from a first detector that detects action of the worker and making the memory store the worker information;
a process of calculating work progress information including a progress speed of the work based on second information acquired from a second detector that detects the work performed by the worker and making the memory store the work progress information;
a process of calculating product information including at least one of a stock quantity of the product and a position of the product based on third information acquired from a third detector that detects the product and making the memory store the product information; and
a process of generating data indicating a connection between at least two types of information, among the worker information, the work progress information and the product information accumulated in the memory, in regard to each of a plurality of predetermined time slots and outputting the data to a display device that presents information.

2. The information analysis device according to claim 1, wherein a connection between the progress speed of the work and the action speed of the worker is generated in each of the plurality of time slots as the data.

3. The information analysis device according to claim 1, wherein a connection between the progress speed of the work and the stock quantity of the product is generated in each of the plurality of time slots as the data.

4. The information analysis device according to claim 1, wherein a connection between the stock quantity of the product and the action speed of the worker is generated in each of the plurality of time slots as the data.

5. The information analysis device according to claim 1, wherein a connection between the position of the worker and the stock quantity of the product is generated in each of the plurality of time slots as the data.

6. The information analysis device according to claim 1, wherein a connection between the position of the worker and the progress speed of the work is generated, in regard to each of the plurality of time slots as the data.

7. The information analysis device according to claim 1, wherein
the product includes a completed final product and an intermediate product before completion, and
when a stock quantity of the intermediate product is judged to be smaller than a predetermined reference quantity in a time slot in which the progress speed of the work is slower than a predetermined reference speed, information indicating that the stock quantity of the intermediate product is small is outputted to the display device.

8. The information analysis device according to claim 1, wherein when it is judged that there is an absent worker whose position is deviated from a predetermined working position in a time slot in which the progress speed of the work is slower than a predetermined reference progress speed, information indicating the absent worker is outputted to the display device.

9. The information analysis device according to claim 1, wherein
the product includes a completed final product and an intermediate product before completion, and
when the action speed of the worker is judged to be slower than a predetermined reference action speed in a time slot in which the stock quantity of the product is smaller than a predetermined reference quantity, information indicating that the stock quantity of the product is small is outputted to the display device.

10. The information analysis device according to claim 1, wherein
the product includes a completed final product and an intermediate product before completion, and
when the action speed of the worker is judged to be slower than a predetermined reference action speed in a time slot in which a stock quantity of the intermediate product is larger than a predetermined reference quantity, information indicating that the action speed of the worker is slow is outputted to the display device.

11. An information analysis method for analyzing information regarding work for producing a product, comprising:
calculating worker information including at least one of an action speed of a worker and a position of the worker based on first information acquired from a first detector that detects action of the worker and making a memory store the worker information;
calculating work progress information including a progress speed of the work based on second information acquired from a second detector that detects the work performed by the worker and making the memory store the work progress information;
calculating product information including at least one of a stock quantity of the product and a position of the product based on third information acquired from a third detector that detects the product and making the memory store the product information; and
generating and outputting data indicating a connection between at least two types of information, among the worker information; the work progress information and the product information accumulated in the memory, in regard to each of a plurality of predetermined time slots.

12. A non-transitory computer-readable storage medium storing an information analysis program for analyzing information regarding work for producing a product, wherein the information analysis program causes a computer to execute processing comprising:
calculating worker information including at least one of an action speed of a worker and a position of the worker based on first information acquired from a first detector that detects action of the worker and making a storage unit store the worker information;
calculating work progress information including a progress speed of the work based on second information acquired from a second detector that detects the work performed by e worker and making the storage unit store the work progress information;
calculating product information including at least one of a stock quantity of the product and a position of the product based on third information acquired from a third detector that detects the product and making the storage unit store the product information; and
generating and outputting data indicating a connection between at least two types of information, among the worker information, the work progress information and the product information accumulated in the storage unit, in regard to each of a plurality of predetermined time slots.
